(19) United States
(12) Patent Application Publication
(10) Pub. No.: US 2012/0222471 A1
(43) Pub. Date: Sep. 6, 2012

(54) METHOD AND APPARATUS FOR MEASUREMENT OF PHYSICAL PROPERTIES OF FREE FLOWING MATERIALS IN VESSELS

(75) Inventors: Alexander M. Raykhman, East Greenwich, RI (US); Francis M. Lubrano, Scituate, RI (US); Eugene Naidis, Ashkelon (IL); Val V. Kashin, Cranston, RI (US); Alex Klionsky, Ashdod (IL); John Couto, Bristol, RI (US)

(73) Assignee: ULTIMO MEASUREMENT, LLC, Scituate, RI (US)

(21) Appl. No.: 13/388,759

(22) PCT Filed: Aug. 3, 2010
(86) PCT No.: PCT/US2010/044292

§ 371 Date: May 17, 2012

Related U.S. Application Data
(60) Provisional application No. 61/230,803, filed on Aug. 3, 2009.

(51) Int. Cl. G01N 29/02

(52) U.S. Cl. 73/64.53

(57) ABSTRACT

Methods and apparatus for non-invasive, simultaneous determination of density and a shear resistance relating variable of a non-gaseous, free flowing material are presented. In one example, the non-gaseous free flowing material is disposed within a vessel at a known or constant level. According to this example, the method and apparatus utilizes an adjustable mathematical model to determine the density and a shear resistance relating variable based on measurements of the system comprising the filling material, the vessel wall and the dynamic measuring instrument interacting with the wall.

### RELATED APPLICATIONS

This application claims priority under 35 U.S.C. §119(e) to U.S. Provisional Application Ser. No. 61/230,803, entitled “METHOD AND APPARATUS FOR MEASUREMENT OF PHYSICAL PROPERTIES OF FREE FLOWING MATERIALS IN VESSELS,” filed on Aug. 3, 2009, which is herein incorporated by reference in its entirety.

### BACKGROUND

1. Field of Invention

Aspects of the present invention relate to systems and methods for non-invasive measurement of mechanical properties of non-gaseous, free flowing matter in a vessel, and more particularly, determining the density and shear resistance relating variables of the non-gaseous, free flowing matter.

2. Discussion of Related Art

Density and viscosity measurement is an indispensable part of many technological processes spanning number of industries including chemical, pharmaceutical, petro and oil, food, building materials and waste water as some examples. Although a number of methods for density and viscosity measurement have been developed over the centuries of industrial evolution, just a few could claim to be capable of measuring density or viscosity non-invasively. Non-invasive measurement of physical properties of non-gaseous materials within vessels is conventionally performed by inspecting the material using one of several approaches. The inspection techniques employed within these approaches may be radiometric, gravitational, optical or ultrasonic in nature.

Radiation-based methods monitor attenuation of radioactive energy passing through a vessel's walls and the material contained within. Unfortunately, radiation-based methods suffer from a number of disadvantages. For instance, density is typically a prime focus of such methods because radiation-based methods are generally not applicable to measurement of shear resistance relating variables like viscosity of liquids or coalescence of solid particles. In addition, density measuring devices that utilize radiation are typically not portable because mounting, calibrating and maintaining accuracy and precision of such devices requires skilled personnel. Moreover, these systems perform with reduced accuracy on densities ranging from 20 to 150 g/L associated with light powder materials such as, for example, Aerosil. Additionally, radiation-based systems typically require special design and operational effort to maintain a sufficient degree of safety. Examples of radiation-based, non-invasive approaches to density measurement of non-gaseous materials include Radiation Uni-Probe LG 491 marketed by Berthold Technologies and the devices and methods described in the following U.S. Pat. Nos. 4,292,522 (Okumoto), 4,506,541 (Cunningham), 6,738,720 (Robins) and 7,469,033 (Kulik et. al.).

Gravitational systems for measuring the density of non-gaseous materials require adjustment to account for the empty vessel's weight and internal dimensions. Gravitation systems are limited in their applicability due to the problems with installation of the weight-measuring equipment which frequently utilize various load cell arrangements. In addition, weight-measuring systems are not applicable to viscosity measurement.

Optical methods are applicable to measuring density of materials in vessels equipped with an aperture for focusing an optical beam through the filling material. U.S. Pat. No. 5,110,208 (Sreepada, et al.) describes one such approach in which the filling material is “ . . . essentially transparent” and may have a “ . . . dispersed phase made up of essentially transparent bubbles, droplets or particles that have smooth, round surfaces.” Optical, non-invasive methods for density measurement have limited use due to the transparency requirements placed on the material to be measured.

Methods that utilize propagation of ultrasonic waves for measurement of the physical properties of materials filling a vessel are of particular interest. Ultrasound-based methods demonstrate excellent ability to discriminate between various properties of the material in the vessel. If applied to liquids, these methods allow measurement of density or viscosity after one of these properties is predetermined. However, conventional measuring methods that utilize ultrasonic waves suffer from several disadvantages.

For example, ultrasound-based methods require a substantial amount of homogeneity of the filling material. Thus, ultrasound-based technologies are not applicable to loose solids and heterogeneous liquids like mud, suspense, pulp or slurry. The presence in the vessel of various kinds of agitating members, mixers or bubblers can produce a similar effect on the accuracy of density or viscosity measurement. In addition, these methods require an ultrasound emitter/receiver attachment to the vessel wall. These attachments typically require special treatment of the container's surface in order to create a conduit for ultrasound waves emitting by a transducer into the container. Moreover, ultrasound-based methods are highly sensitivity to disturbances affecting the speed of sound in the medium, e.g., temperature and flow variations. Thus, special compensation techniques are conventionally employed to provide for the invariance of the output variables to these disturbances. Also, the amount of power consumed by an ultrasound transducer in providing a sufficient pulsation could limit the applicability of these methods.

Examples of various implementations of ultrasound density or viscosity measurement are disclosed in the following U.S. patents and U.S. patent applications: U.S. Patent Application 20030089161, U.S. Pat. No. 7,059,171 (Gysling), for measuring density of flowing liquids only; U.S. Pat. No. 5,359,541 (Pope, et al.) which is limited to measuring density of liquids in vessels with acoustical emitter and receiver positioned at the opposing sides of the vessel; U.S. Pat. No. 6,945,094 (Eggen, et al.) for measuring rheological properties of flowing liquids only; U.S. Pat. No. 5,686,661 (Singh) for measuring viscosity of high density molten materials; U.S. Pat. No. 6,194,215 (Rauh, et al.) for measurement and control of composition of a solution. Some ultrasound-based methods include acts (and some devices utilizing the method include means) for minimizing the influence of the shear resistance of the filling material when measuring density.

### SUMMARY OF INVENTION

Aspects and examples disclosed herein manifest an appreciation that simultaneous measurement of density and shear resistance relating variables (e.g., viscosity of homogeneous liquids) creates an opportunity for widening measurement range, improving measurement accuracy and providing greater versatility to ultrasound methods for measurement of physical properties of non-gaseous materials. Additionally, aspects and examples disclosed herein manifest an appreciation that all known non-invasive filling material measurement techniques are limited at least by the factors of filling material, environment and simultaneous effect of different material properties on the output variables of respective measuring systems. Thus at least some examples develop a vibration-based method for a simultaneous non-invasive measurement of the vessel content density and shear resistance relating variables that is free of the aforementioned limitations.

According to one example, a method for non-invasive simultaneous measurement of density and shear resistance relating variables of a non-gaseous free flowing matter filling a vessel to a known level or to a constant level is provided. The method includes acts of initializing vibration at least at a single predetermined position on the outside wall of the vessel filled to a predetermined level with non-gaseous free flowing matter, capturing the wall oscillatory response to the mechanical load, analyzing the captured response, producing values of at least two evaluating variables resulting from the analysis, populating a filling material-linked system of equations including at least one filling material density-relating variable and one shear resistance relating variable as unknowns and at least one value of the first evaluating variable and one value of the second evaluating variable, and solving the system of equations against the unknowns, whereby providing simultaneous non-invasive measurement of the density-relating variable and the shear resistance relating variable of the filling material existing in the associate volume in the vicinity of the center of the mechanical load applied to the vessel wall.

According to another example, an apparatus for non-invasive simultaneous measurement of density and shear resistance relating variables of a non-gaseous free flowing matter filling a vessel to a known level or to a constant level is provided. The apparatus includes a mechanism for generating a temporal mechanical load at the outside wall of the vessel, a mechanism for controlling the dynamic parameters of the temporal load, a mechanism for receiving and directing for further processing the wall oscillatory response, a mechanism for analyzing the oscillatory response and producing evaluating variables resulting from the analysis, a mechanism for populating equations participating in the measurement process, a mechanism for solving the equations and producing measured values of the sought variables and a mechanism for delivering value of the sought variables and any additional variables values contingent on the measured variables outside of the apparatus.

The method and the apparatus allow for simultaneous measurement of density and viscosity of homogeneous liquids, bulk density and viscosity of heterogeneous liquids and bulk density and shear resistance relating variable of loose solid materials.

According to another example, a method for non-invasive simultaneous measurement of density and shear resistance relating variable of a non-gaseous free flowing matter filling a vessel is provided. The method comprises the acts of: determining an optimal value of kinetic energy that should be induced in to the outside wall of a vessel following the moment of application of the temporal mechanical load directed at the wall; initializing vibration at least at a single predetermined position on the outside wall of the vessel filled to a predetermined level with non-gaseous free flowing matter; capturing the wall oscillatory response to the mechanical load; analyzing the captured response; producing values of at least two evaluating variables resulting from the analysis; populating a filling material-linked system of equations including at least one filling material density-relating variable and one shear resistance relating variable as unknowns and at least one value of the first evaluating variable and one value of the second evaluating variable as the parameters of the system of equations; and solving the system of equations against the unknowns, whereby providing simultaneous non-invasive measurement of the density-relating variable and shear resistance relating variable of the filling material present in the associate volume in the vicinity of the center of the mechanical load applied to the vessel wall.

In the method, the filling material may be a homogeneous liquid, a heterogeneous liquid, or a loose solid material. Additionally, in the method, the vibration may originate through a mechanical temporal load applied to the outside wall of the vessel; the load being actuated by one of a solid material body interaction with the wall, a fluid-dynamic interaction including air and liquid agent, a ballistic percussion and an electro-dynamic interaction.

In the method, the mechanical load may include a single pulse, a trainload of pulses and a continuous periodical load. Additionally, in the method, the mechanical load may be modulated as one of an amplitude modulation, a frequency modulation, a pulse modulation, a pulse-code modulation, a pulse-width modulation and a combination thereof, and the mechanical load may be originated by the transformation of a source of driving energy selected from one of an electromagnetic drive, a mechanical energy used in springs, a pneumatic apparatus, a hydraulic apparatus and a ballistic percussive apparatus.

In the method, the act of capturing may include an act of converting the oscillation into a signal acquirable by a signal processing mechanism and further analyzable by a data processing mechanism resulting in creating a set of informative variables serving as an input for generating evaluating variables of the method. In the method, an outcome of the captured signal analysis includes but not limited to at least one of the following sets of the informative variables characterizing the strength of the wall response to the strike: a) set of maximums of the filtered and rectified signal obtained on a moving time-window greater then a sampling period; b) sum of the maximums; c) sum of differences between the adjacent maximums. In addition, in the method, the outcome of the captured signal analysis may be the wall response time calculated under the condition that the captured signal is greater then a set threshold. Moreover, in the method, the outcome of the captured signal analysis may be the signal logarithmic decrement or damping factor. Additionally, in the method, the outcome of the captured signal analysis may be the signal harmonic spectrum.

In the method, the act of determining an optimal value of kinetic energy may include the acts of: initializing vibration of the wall by striking at the wall at certain beginning value of the kinetic energy; capturing the sensor response; evaluating the sensor output signal against the criteria of the signal representation; adjusting the value of the kinetic energy that the striker induces in the wall according to an optimization paradigm; returning to the act of initializing vibration if the optimization is not achieved; and using the obtained optimal value of kinetic energy in the measurement.

In the method, the first evaluating variable may be built on the set of informative variables characterizing the strength of the wall response and; the second evaluating variable may be built on the set of informative variables characterizing the captured oscillating response temporal properties. Additionally, in the method, the first evaluating variable may relate to the captured wall's vibration response and; the second evaluating variable may relate to the captured oscillatory response representing at least one elastic wave propagating through the wall and the filling material, wherein the vessel is filled with homogeneous liquid.

In the method, at least one of the evaluating variables may be built on the set of informative variables characterizing the strength of the wall response. Also, according to the method, at least one of the evaluating variables may be built on the set of informative variables characterizing the wall oscillatory response temporal properties. Further, in the method, at least one of the evaluating variables may be built on the set of informative variables characterizing a combination of the captured oscillatory response amplitude and temporal properties including and is not limited to mechanical power and mechanical work produced by the wall on the duration of the captured oscillatory wall response.

In the method, the predetermined system of equations may include the evaluating variables and the matching number of calculated variables such that each evaluating variable makes a pair with the corresponding calculated variable; both components of the pair of variables described by equal dimensional units. In addition, in the method, at least one calculated variable may be a function of the density-relating variable and at least one calculated variable may be a function of the shear resistance relating variable.

In the method, the predetermined system of equations may have the following structure:

$$\{ \begin{matrix}{S}_{m} - {S}_{c} [ F ( ρ , μ ) ] = 0 \\ {Q}_{m} - {Q}_{c} [ U ( ρ , μ ) ] = 0\end{matrix}$$

Wherein Sₘ denotes the first measured evaluating variable value; Qₘ denotes the second measured evaluating variable value; S_{c} denotes the first calculated evaluating variable; Q_{c} the second calculated variable; functions F(ρ, μ) and U(ρ, μ) represent natural laws regulating the relationships between the variables (Sₘ,Qₘ) and the sought variables (ρ, μ) with the density-relating variable denoted by ρ and the shear resistance relating variable denoted by μ. The functions F(ρ, μ) and U(ρ, μ) represent a mathematical model of a dynamic system comprised of a mechanical impact creating element interacting with the vessel wall, and the wall interacting with the filling material.

The method may further include a system of Navier-Stokes equations in the mathematical model, wherein the filling material is a liquid. The method may further include a system of Burgers-like equations in the mathematical model, wherein the filling material is a loose solid.

In the method, where one of the unknown sought variables (ρ, μ) is predetermined, the method may include solving a single equation:

Wₘ−W_{c}[N(λ)]=0

Wherein Wₘ denotes the measured value of the evaluating variable; W_{c} denotes the calculated evaluating variable; function N(λ) represent natural laws regulating the relationship between the variable Wₘ and the sought variable λ=ρ [symbol] μ. In the method, if the mathematical model W_{c}[N(λ)] is unavailable, the method may include an act of performing the sought variable measurement by executing a measurement procedure comprising 2 acts. According to the method, the first act may include substituting the mathematical model W_{c}[N(λ)] with an experimental curve denoted by W_{ce}({λ*}), {λ*}ε[λ′,λ″] and a set of pre-measured values of the variable A denoted by {λ*} and the second act may includes solving the equation Wₘ−W_{ce}(λ)=0 against the unknown sought variable λ=ρ [symbol] μ. Additionally, the first act operation of the measurement procedure may be a multiple point measurement process with the minimal number of measurements equal to two and the operation is describable by the following system of algebraic equations:

$${{W}^{->}}_{m}^{*} - {W}_{ce} ( {{λ}^{->}}^{*} ) = 0$$

$${W}_{ce} ( {{λ}^{->}}^{*} ) = {\sum }_{i = 1}^{K} {{a}_{i} ( {{λ}^{->}}^{*} )}^{( i )}$$

$${{λ}^{->}}^{*} ⋐ \{ {λ}^{*} \} , K \geq 2$$

Wherein, \vec{W}*ₘ denotes a vector-column of values of the measured evaluating variable W; \vec{λ}* denotes a vector-column of pre-measured values of the sought variable λ=ρ [symbol] μ.

According to another aspect, an apparatus for non-invasive simultaneous measurement of density and shear resistance relating variable of a non-gaseous free flowing matter filling a vessel is provided. The apparatus includes a mechanism for generating a temporal mechanical load at the outside wall of the vessel; a mechanism for controlling the dynamic parameters of the temporal load; a mechanism for receiving and directing for further processing the wall oscillatory response; a mechanism for analyzing the oscillatory response and producing evaluating variables resulting from the analysis; a mechanism for populating equations participating in the measurement process; a mechanism for solving the equations and producing measured values of the sought variables; and a mechanism for delivering the sought variables values and any additional variables values contingent on the measured variables outside of the apparatus.

The mechanisms of the apparatus may include a plurality of mechanical, electrical, electronic hardware and software elements meant for creating a computer readable environment, providing for functioning a measuring system or measuring mechanisms implementing non-invasive simultaneous measurement of density and shear resistance relating variable of the free flowing matter filling the vessel. One example of a computer system including hardware and software elements is discussed further with reference to FIG. 14, below. Furthermore, the function of generating a temporal mechanical load at the outside wall of the vessel may be attributed to Striker-unit of the measuring mechanism. In addition, the function for controlling the dynamic parameters of the temporal load may be attributed to Strike Control-unit of the measuring mechanism. Moreover, the function for receiving and directing for further processing the wall oscillatory response is attributed to Receiver-unit of the measuring mechanism. Additionally, the function for analyzing the oscillatory response and producing evaluating variables resulting from the analysis may be attributed to Analyzer-unit of the measuring mechanism. Further, the function for populating equations participating in the measurement process may be attributed to Equations Generator-unit of the measuring mechanism. Also, the function for solving the equations and producing measured values of the sought variables may be attributed to Equations Solver-unit of the measuring mechanism and the function for delivering the sought variables values and any additional variables values contingent on the sought variables outside of the foregoing may be attributed to apparatus Output Interface-unit of the measuring mechanism.

In the apparatus, the output of the Receiver-unit may be connected to the input of the Analyzer-unit and; the first output of the Analyzer-unit may be connected to the first input of the Strike Control Unit, which first output may be connected to the first input of the Striker-unit and second output may be connected to the second input of the Striker-unit; the second output of the Analyzer-unit may be connected to the second input of the Strike Control Unit, which second output may be connected to the second input of the Striker and second output may be connected to the second input of the Striker; the third output of the Analyzer-unit may be connected to the first input of the Equation Generator-unit, and the pre-determined guess value for the density variable may be the 2nd input of the Equations Generator-unit, and the pre-determined guess value of the shear resistance relating variable may be the 3rd input of the Equations Generator-unit and; the output of the Equations Generator-unit may be connected to the input of the Equations Solver-unit, which first output may be the measured density variable, and which second output may be the measured shear resistance relating variable and; the first output of the Equations Solver-unit may be connected to the first input of the Output Interface-unit, and the second output of the Equations Solver-unit may be connected to the second input of the Output Interface-unit and; the first output of the Output Interface-unit delivers information about the measured density outside the apparatus, and the second output of the Output Interface-unit delivers information about the measured shear resistance relating variable outside the apparatus, and the third output of the Output Interface may be a vector of binary alarms for various versions of ON/OFF control.

In the apparatus, the Striker-unit may be driven by a combination of input signals coming from the Strike Control-unit, and the Striker-unit may apply a mechanical impact of the type of a single pulse, a series of pulses or a modulated continuous periodical load at the wall of the vessel. Additionally, in the apparatus the Striker-unit may comprise of the two functional elements and the first functional element may be responsible for producing the temporal load in accordance with a certain speed—time diagram and the second functional element may be responsible for producing the temporal load in accordance with a certain striking mass—time diagram and both channels functioning may be synchronized, thereby allowing transient control of the amount of kinetic energy generated by the temporal mechanical load.

In the apparatus, the functional channels may utilize electromagnetic energy of solenoids or electrical motors. Additionally, in the apparatus, the functional channels may utilize hydraulic or pneumatic driving system. Further, in the apparatus, the functional elements utilize a magnetostrictive actuation. Moreover, the functional elements may utilize a pieso-transducer actuation. In addition, the functional elements utilize a ballistic actuation. Furthermore, the functional elements utilize an actuation based on possible combination thereof.

In the apparatus, the Receiver-unit that captures the wall's oscillatory response may be comprised of the mechanical oscillation receiving mechanism, and the response-proportional signal forming mechanism and the response-proportional signal forming mechanism may perform signal conditioning, quantifying, storing and other operations required for delivering the signal to the Analyzer-unit.

In the apparatus, the Analyzer-unit may performs operations on the response-proportional signal forming at least three types of variables and the first variable-type, meant for optimizing the quality of the signal captured by the Receiver-unit, may be associated with the first bus-output of the Analyzer-unit and the second variable-type, meant for optimizing the quality of the signal captured by the Receiver-unit, may be associated with the second bus-output of the Analyzer-unit and the third variable-type may be associated with the third bus-output of the Analyzer-unit including at least two evaluating variables meant for feeding the Equations Generator-unit. In the apparatus, the Strike Control-unit may optimize the amount of kinetic energy induced into the wall by the Striker-unit through controlling driving systems of the functional elements of the Striker-unit in accordance with the kinetic energy optimization method and the 1st output of the Strike Control-unit may enable the speed control of the Striker-unit and the 2nd output of the Strike-Control-unit enables the control of the effective mass of the Striker-unit.

In the apparatus, the Equations Generator-unit may accept the evaluating variables from the third bus-output of the Analyzer-unit to populate the system of governing equations of the method and the pair of guess values of the sought density variable associated with the second input of the Equations Generator-unit and the sought shear resistance relating variable associated with the third input of the Equations Generator-unit may create a guess vector required for numerically solving the system of governing equations and the components of the guess vector may be stored in the manageable database of the Equations Generator-unit and the bus-output of the Equations Generator-unit may be the numerically-populated system of the governing equations meant to be solved by the Equations Solver-unit.

In the apparatus, the Equations Solver-unit may executes at least one method suitable to solving the class of equations supplied by the Equations Generator-unit producing the numerical values of the density and the shear resistance relating variable associated with the instance of the filling material transient state at the moment the Receiver-unit's output has been captured.

In the apparatus, when configured to process homogeneous liquids, the output-bus of the Equations Solver-unit may include density and dynamic viscosity. Additionally, the output-bus of the Equations Solver-unit may include bulk density, when configured to process heterogeneous liquids. Moreover, the output-bus of the Equations Solver-unit may include bulk density and shear resistance relating variable, when configured to process loose solids.

The apparatus may include analog or digital input interfaces and, in the apparatus, any analog or digital input interface or analog or digital output interface may be comprised of hardware or software or combined hardware and software. In addition, the interface may represent a functionality of vectorial data communication within the computing and controlling mechanism and other functional units of the apparatus. The functional units and interfaces may have multiple implementations including a single part design and the functional units and interfaces may have multiple implementations including a two-part design with Striker-unit, Strike Control-unit and Receiver-unit situated in the one enclosure and the rest of the apparatus situated in the another enclosure.

According to another aspect, an apparatus for non-invasive simultaneous measurement of mass flow, density and shear resistance relating variable of a non-gaseous free flowing matter filling a vessel is provided. The apparatus includes an apparatus for non-invasive simultaneous measurement of mass flow, density and shear resistance relating variable of a non-gaseous free flowing matter filling a vessel and an apparatus for non-invasive measurement of volumetric flow of a non-gaseous free flowing matter traveling through a vessel, whereby allowing simultaneous measurement of mass flow, density and shear resistance relating variable by producing the mass flow measurement by performing multiplication of the measured density by the measured volumetric flow. The apparatus may further include an ultrasound Doppler Effect-based flow meter for volumetric flow measurement.

According to another example, a method for non-invasive simultaneous measurement of density and shear resistance relating variable of a non-gaseous free flowing matter filling a vessel is provided. The method includes acts of determining an optimal value of mechanical energy that should be induced into the vessel outside wall following the moment of application of the temporal mechanical load directed at the wall; initializing vibration at least at a single predetermined position on the outside wall of the vessel filled to a known level with non-gaseous free flowing matter; capturing the wall oscillatory response to the mechanical load; analyzing the captured response; producing values of at least two evaluating variables resulting from the analysis; populating a filling material-linked system of equations including at least one filling material density-relating variable and one shear resistance-relating variable as unknowns and at least one value of the first evaluating variable and one value of the second evaluating variable and solving the system of equations against the unknowns, whereby providing simultaneous non-invasive measurement of the density-relating variable and shear resistance-relating variable of the filling material present in the associate volume in the vicinity of the center of the mechanical load applied to the vessel wall.

In the method, said filling material may be a heterogeneous material and said heterogeneous material may be a mix of liquid and solid materials or a multiphase liquid with or without a clear interface between the component materials. In addition, the vibration may originate through a mechanical temporal load applied to the outside wall of the vessel; the load may be actuated by one of a solid material body interaction with the wall, a fluid-dynamic interaction including air and/or liquid agent, a ballistic percussion and an electro-dynamic interaction. Further, the outcome of the captured signal analysis may include at least one of the following sets of said informative variables characterizing the wall response to said strike: a) set of maximums of the filtered and rectified alternating signal obtained on a moving time-window greater then a sampling period; b) sum of said maximums; c) sum of differences between the adjacent maximums. Moreover, the outcome of the captured signal analysis may include the signal's harmonic spectrum.

In the method, an optimization of the amount of mechanical energy induced into the wall may be performed by executing the following acts: setting the initial and ending values of the dynamic range and sensitivity of the vibration sensing mechanism, thereby creating an outer loop of the strike control; initializing vibration of the wall by striking at the wall at certain beginning value of the kinetic energy, thereby creating an inner loop of the strike control; capturing the sensor response; evaluating the sensor output signal against the criteria of the signal representation; verifying that the strike optimization is achieved; using the obtained optimal value of kinetic energy in the measurement if the strike optimization is achieved; if the strike optimization is not achieved, then adjusting the value of the kinetic energy that the striker induces in the wall according to an optimization paradigm; returning to said initializing vibration step, thereby closing an inner loop of the strike control; changing the dynamic range and/or sensitivity of the vibration sensing means if the strike optimization is not achieved with the inner loop, thereby closing an outer loop of the strike control; executing the second step of the strike control method and using the obtained optimal value of kinetic energy in the measurement if the strike optimization is achieved.

According to another example, an apparatus for non-invasive simultaneous measurement of density and shear resistance relating variable of a non-gaseous free flowing matter filling a vessel is provided. The apparatus includes a mechanism for generating a temporal mechanical load at the outside wall of the vessel; a mechanism for controlling the dynamic parameters of said temporal load; a mechanism for receiving and directing for further processing said wall oscillatory response; a mechanism for analyzing said oscillatory response and producing evaluating variables resulting from said analysis; a mechanism for populating equations participating in the measurement process; a mechanism for solving said equations and producing measured values of said sought variables and a mechanism for delivering said sought variables values and any additional variables values contingent on said measured variables outside of said apparatus.

In the apparatus, the output of the Receiver-unit may be connected to the input of the Analyzer-unit; the first output of the Analyzer-unit may be connected to the first input of the Strike Control Unit, which output is connected to the input of the Striker-unit; the second output of the Analyzer-unit may be connected to the first input of the Equation Generator-unit; the third output of the Analyzer-unit may be connected to the second input of the Receiver-unit; the pre-determined guess value for the density variable includes the second input of the Equations Generator-unit, and the pre-determined guess value of the shear resistance-relating variable includes the third input of the Equations Generator-unit; the output of the Equations Generator-unit may be connected to the input of the Equations Solver-unit, which first output includes the measured density variable, and which second output includes the measured shear resistance-relating variable; the first output of the Equations Solver-unit may be connected to the first input of the Output Interface-unit, and the second output of the Equations Solver-unit may be connected to the second input of the Output Interface-unit; the first output of the Output Interface-unit may deliver information about the measured density outside the apparatus of the present invention, and the second output of the Output Interface-unit may deliver information about the measured shear resistance-relating variable outside the apparatus of the present invention, and the third output of the Output Interface includes a vector of binary alarms for various versions of ON/OFF control.

In the apparatus, the Analyzer-unit may perform operations on said response-proportional signal forming at least three types of variables; the first variable-type, meant for optimizing the quality of the signal captured by the Receiver-unit, may be associated with the first output of the Analyzer-unit; the second variable-type may be associated with the second bus-output of the Analyzer-unit including at least two evaluating variables meant for feeding the Equations Generator-unit; the third variable-type, meant for optimizing the quality of the signal captured by the Receiver-unit by controlling selection of setup parameters of said vibration receiving mechanism, may be associated with the third output of the Analyzer-unit. In addition, the Strike Control-unit may optimize the amount of kinetic energy induced into the wall by the Striker-unit through controlling the driving systems of said functional elements of the Striker-unit in accordance with the kinetic energy optimization method. Further, the output-bus of the Equations Solver-unit may contain density and dynamic viscosity; the output-bus of the Equations Solver-unit may contain bulk values of density and viscosity; and, the output-bus of the Equations Solver-unit may contains bulk density and shear resistance-relating variable.

According to another example, an apparatus for non-invasive simultaneous measurement of mass flow, density and shear resistance relating variable of a non-gaseous free flowing matter filling a vessel is provided. The apparatus includes an apparatus for non-invasive simultaneous measurement of mass flow, density and shear resistance relating variable of a non-gaseous free flowing matter filling a vessel and an apparatus for non-invasive measurement of volumetric flow of a non-gaseous free flowing matter traveling through a vessel, thereby allowing simultaneous measurement of mass flow, density and shear resistance-relating variable by producing the mass flow measurement by performing multiplication of the measured density by the measured volumetric flow. The apparatus may further include one application wherein the volumetric flow measurement is preformed by an ultrasound Doppler Effect-based flow meter.

According to another example, an apparatus for non-invasive simultaneous layer-by-layer measurement of density and shear resistance relating variable of a non-gaseous free flowing matter filling a vessel is provided. The apparatus includes an apparatus for simultaneous non-invasive simultaneous measurement of density and shear resistance relating variable of a non-gaseous free flowing matter filling a vessel and a system of acoustic transducers situated coaxially on the opposite ends of the vessel. In the apparatus, said first transducer may emit an elastic wave protruding though the vessel wall and vessel content; said second transducer may receive said elastic wave emitted by the first transducer and said elastic wave generation may be synchronized with strikes of said apparatus for simultaneous non-invasive simultaneous measurement of density and shear resistance relating variable. In addition, the apparatus may further cause sequential modification of the mechanical energy of said strikes to gradually increase the associate volume of the vessel content material participating in oscillations in the direction normal to the wall surface resulting in a superposition of elastic waves and oscillation of said associate volume of the vessel content material, thereby allowing layer-by-layer measurement of density and shear resistance variable of the content material.

According to another example, a method for measuring physical properties of material in a vessel is provided. The method includes acts of initiating a vibration on a wall of the vessel; capturing a response to the vibration; producing values for at least two evaluating variables based on the response and solving a system of equations including at least one density variable and at least one shear resistance variable using the at least two evaluating variables.

In the method, the act of initiating the vibration may include an act of applying a mechanical load to an outside wall of the vessel. In addition, the act of applying the mechanical load may include an act of applying at least one of a single pulse, a trainload of pulses and a continuous periodic load. Further, the act of initiating the vibration may include an act of initiating a vibration in the material, the material being at least one of a homogeneous liquid, a loose solid material and a heterogeneous material including a mixture of liquid and solid materials. Moreover, the act of capturing the response may include an act of capturing informative variables characterizing the wall response to the vibration.

The method may further include an act of analyzing the response to determine at least one of a set of maximums of an alternating signal obtained on a moving time-window greater then a sampling period, a sum of the set of maximums and a sum of differences between adjacent maximums of the set. In addition, the method may further include an act of analyzing the response to determine a signal logarithmic decrement or damping factor. Further, the method may further include an act of analyzing the response to determine a harmonic spectrum of a signal. Moreover, the method may further include an act of adjusting an amount of kinetic energy used to initiate the vibration by analyzing the response. In the method, the act of adjusting the amount of kinetic energy may include an act of verifying the amount of kinetic energy results in another response to a vibration that meets a predetermined set of threshold characteristics.

According to another example, an apparatus for measuring physical properties of material in a vessel is provided. The apparatus includes a striker configured to initiate a vibration on a wall of the vessel; a sensor configured to capture a response to the vibration and a controller configured to produce values for at least two evaluating variables based on the response and solve a system of equations including at least one density variable and at least one shear resistance related variable using the at least two evaluating variables.

In the apparatus, the striker may be configured to apply a mechanical load to an outside wall of the vessel. In addition, the mechanical load may include at least one of a single pulse, a trainload of pulses and a continuous periodic load. Further, the material may include at least one of a homogeneous liquid, a loose solid material and a heterogeneous material including a mixture of liquid and solid materials. Moreover, the sensor may be configured to capture informative variables characterizing the wall response to the vibration. Additionally, the controller may be further configured to analyze the response to determine at least one of a set of maximums of an alternating signal obtained on a moving time-window greater then a sampling period, a sum of the set of maximums and a sum of differences between adjacent maximums of the set.

In the apparatus, the controller may be further configured to analyze the response to determine a signal logarithmic decrement or damping factor. In addition, the controller may be further configured to analyze the response to determine a harmonic spectrum of a signal. The apparatus may further include a strike controller coupled to the striker and the sensor and configured to adjust, by analyzing the response, an amount of kinetic energy used by the striker to initiate the vibration. In this example, the strike controller may be further configured to verifying the amount of kinetic energy results in another response to a vibration that meets a predetermined set of threshold characteristics.

Still other aspects, examples, and advantages of these exemplary aspects and examples, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of the invention. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is a one-dimensional block diagram describing the behavior of a non-Newtonian liquid within a vessel wall when the wall is actuated by an impact from the striker at a direction normal to the wall;

FIG. 2 is a one-dimensional block diagram describing the behavior of a loose solid matter within a vessel wall when the wall is actuated by an impact from the striker at a direction normal to the wall;

FIG. 3 is a functional diagram of an experimental installation for testing a method for determining density and a shear resistance relating variable of liquid filling materials;

FIG. 4a is graphical representation of a test tank wall's oscillatory response measured in standard units (s.u.) of oscillation monitoring device (OMD) output to kinematic viscosity of testing liquids measured in cSt;

FIG. 4b is graphical representation of the test tank wall's oscillatory response measured in standard units (s.u.) of OMD output to kinematic viscosity of testing liquids measured in cSt;

FIG. 5 is a schematic diagram of the test pipe mounted with an OMD;

FIG. 6 is a graphical representation of the test tank wall's oscillatory response measured in standard units (s.u.) of OMD output to bulk density of a powder sample measured in g/L;

FIG. 7 is a bar-graph demonstrating dependence of OMD output from the OMD vertical position on the wall and the presence of non-OMD-generated vibration applied to the body of the test vessel;

FIG. 8 is a simulated time-diagram demonstrating a vibration sensor output fundamental harmonic depending on the degree of change in the powder sample bulk density;

FIG. 9 is a functional block diagram of an apparatus for determining density and a shear resistance relating variable;

FIG. 10 is a generalized block diagram of one version of the adaptive strike control subsystem for an apparatus for determining density and a shear resistance relating variable;

FIG. 11 is a block diagram of the adaptive strike control subsystem of an apparatus for determining density and a shear resistance relating variable;

FIG. 12 is a schematic diagram providing an explanation of a principle of operation of a cross profiling of density/viscosity measurement application;

FIG. 13 is a flow diagram of a method for determining density and a shear resistance relating variable; and

FIG. 14 is a block diagram of one example of a computer system that may be used to perform processes disclosed herein.

### DETAILED DESCRIPTION

Aspects and examples disclosed herein relate to apparatus and processes for determining physical properties of a material housed within a vessel. For instance, according to one example, an apparatus includes a striker, vibration sensor and controller configured to determine the density and a shear resistance relating variable of a non-gaseous material disposed within a vessel. In some examples, the non-gaseous material is a fluid. In other examples, the non-gaseous material is a solid. According to another example, an apparatus, such as the apparatus described above, executes a method for determining physical properties of a material housed within a vessel. While executing the exemplary method, the apparatus determines the density and a shear resistance relating variable of a non-gaseous material disposed within the vessel by populating a system of equations with empirical data and solving the system of equations.

It is to be appreciated that examples of the methods and apparatuses discussed herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, acts, elements and features discussed in connection with any one or more examples are not intended to be excluded from a similar role in any other examples.

Also, the phraseology and terminology used herein is for the purpose of description and should not be regarded as limiting. Any references to examples or elements or acts of the systems and methods herein referred to in the singular may also embrace examples including a plurality of these elements, and any references in plural to any example or element or act herein may also embrace examples including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

### Measurement Processes

Exemplary methods disclosed herein are based on monitoring the oscillatory motion of the outside wall of a vessel. Such motion may be initiated by the application of a temporal mechanical load directed at the wall. The method exploits the properties of the two-region dynamic system “Vessel's wall-Filling material” such that at a relatively short distance between the load point, the oscillation of the mechanical dynamic system “instant associate filling material mass-instant associate vessel wall mass,” is used to obtain information for simultaneously determining the density and the shear resistance relating variable characterizing the non-gaseous free flowing matter in the vessel. The method of measurement is applicable to both basic types of non-gaseous free flowing vessel contents that are liquid materials, homogeneous and non-homogeneous; and loose solids including powders and other granulated materials. In the case of liquids, the shear resistance relating variable of the method is associated with the viscosity of liquids. In the case of loose solids and non-homogeneous liquids, the density variable of the method represents the bulk density of these materials.

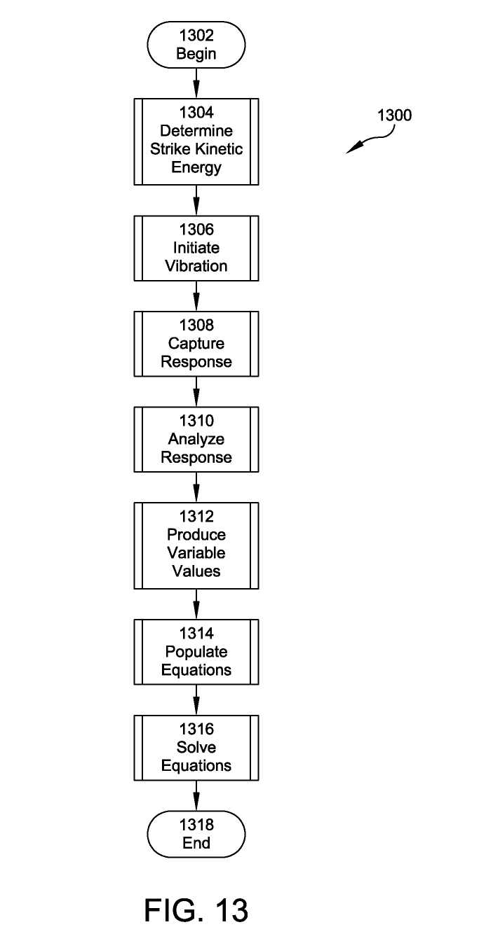

Integrally, the developed process 1300 is a sequence of the following acts, as illustrated in FIG. 13. Process 1300 begins at 1302. At 1304, a measurement apparatus determines an optimal value of kinetic energy that should be induced in to the vessel wall following the moment of application of the temporal mechanical load directed at the wall. At 1306, the measurement apparatus initiates vibration at least at a single predetermined position on the outside wall of the vessel filled with non-gaseous free flowing matter to the known level. At 1308, the measurement apparatus captures the wall's oscillatory response to the mechanical load. At 1310, the measurement apparatus analyzes the captured response. At 1312, the measurement apparatus produces values of at least two evaluating variables resulting from the analysis. At 1314, the measurement apparatus populates a system of theoretical equations including at least one filling material density-relating variable and one shear resistance relating variable as unknowns and at least one value of the first evaluating variable and one value of the second evaluating variable. At 1316, the measurement apparatus solves the system of equations against the unknowns, whereby providing simultaneous non-invasive measurement of the density-relating variable and the shear resistance relating variable of the filling material present in the associate volume in the vicinity of the center of the mechanical load applied to the vessel wall. Process 1300 ends at 1318.

Below, each act of the proposed method is described in detail for the method's minimal version of a single source of vibration.
Act 1304: Determining an optimal value of kinetic energy that should be induced in to a vessel wall following the moment of application of the temporal mechanical load directed at the wall

According to the physics of the disclosed method of measuring by percussion, the point level, density or viscosity measurement requires that the sensor output signal satisfy certain conditions of a signal representation. This condition may include a dynamic range value, a time-based window of observation value and a signal decaying behavior. An adaptive strike control process is suggested to support the sensor output signal's satisfaction of the conditions of the signal representation regardless of parameters of the measurement application. The process performs an optimization of the value of kinetic energy that the striker induces into the vessel wall and requires performance of the following operations prior to the beginning measurement:
Initializing vibration of the wall by striking at the wall at certain beginning value of the kinetic energy
Capturing the sensor response
Evaluating the sensor output signal against the criteria of the signal representation
Adjusting the value of the kinetic energy that the striker induces in the wall according to an optimization paradigm, such as steepest descend method
Returning to the act of initializing the vibration if the optimization is not achieved
Using the obtained optimal value of kinetic energy in the measurement after the optimization is achieved
Act 1306: Initializing vibration at least at a single predetermined position on the outside wall of a vessel filled with some matter to a predetermined level.

The vibration originates in the neighborhood of a mechanical impact with its center located on the outside wall of the vessel. The impact load's time diagram could be of various forms including a single pulse, a trainload of pulses or a continuous periodical load as particular examples. Each load-type allows any kind of modulation, for example, Amplitude Modulation, Frequency Modulation, Pulse-Code Modulation, or their combinations. In some examples, the mechanical impact at the wall may originate via an application of any suitable energy source depending on the technical requirements of the particular measurement project. Suitable energy sources may include a solenoid, a spring, a hydraulic and an air pressure-based drives.
Act 1308: Capturing the wall oscillatory response to the mechanical load.

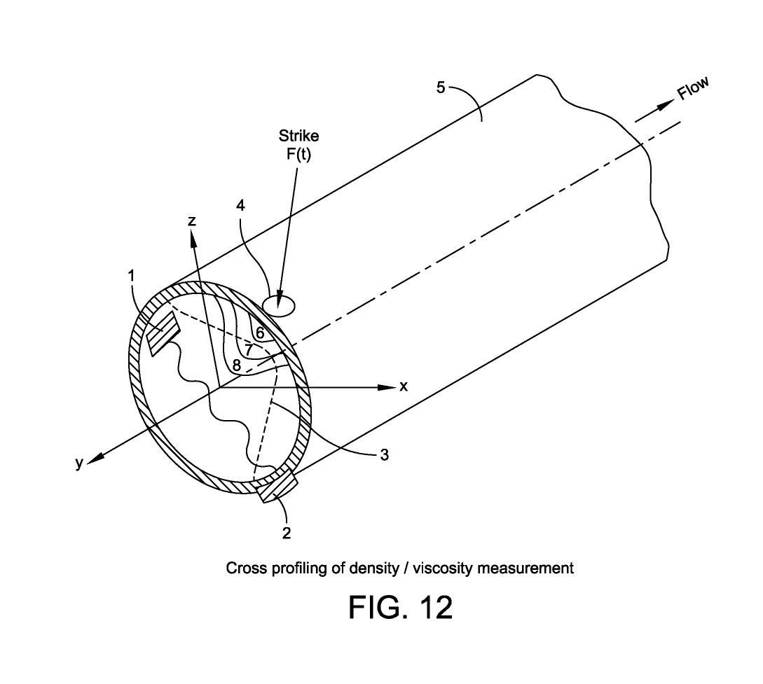

A mechanical vibration captured by the receiver of the measuring system is quantified and stored in data storage, such as the data storage described below with reference to FIG. 12, for further analysis.
Act 1310: Analyzing the captured response

The stored, quantified dataset is an input for a consequent data processing operation performed by a controller that is coupled to a data storage. This data processing operation results in the generation of a vector of informative variables characterizing energy, temporal and frequency spectral properties of the vibration response or signal that can be described but not limited by the following examples. The vibration energy-characterizing variables could include: a) set of maximums of the rectified vibro-signal obtained on a moving time-window greater then a sampling rate; b). Sum of these maximums; c). Sum of differences between the adjacent maximums. The vibration signal's temporal properties could be evaluated by the response time calculated under the condition that the captured signal is greater then a set threshold. Another variable, characterizing the signal temporal properties is the signal logarithmic decrement or damping factor. The spectral frequency properties could be evaluated by the signal's harmonic representation through the application of the Fast Fourier Transform Procedure delivering the signal's amplitude spectrum defined on a frequencies range.
Act 1312: Producing values of at least two evaluating variables resulting from the analysis

The two evaluating variables are built on the vector of informative variables generated in the Act 1310. The goal of this example is the measurement of at least two mechanical properties of the filling material; hence at least two evaluating variables are required to participate in the equations solving process. The two evaluating variables consequently denoted by Sₘ,Qₘ, must be in the relationship with each of the two variables which values are to be measured:

Sₘ=Sₘ(ρ,μ)

Qₘ=Qₘ(ρ,μ) (1.1)

Wherein, the variable ρ denotes the filling material density-relating variable; the variable μ denotes the filling material shear resistance relating variable and the index m stands for “measured.” For example, both logarithmic decrement and fundamental harmonic of the vibro-signal depend on (ρ, μ), satisfying the condition (1.1).
Act 1314: Populating a system of theoretical equations including at least one filling material density-relating variable and one shear resistance relating variable as unknowns and at least one value of the first evaluating variable and one value of the second evaluating variable

A pre-determined system of governing equations includes measured variables Sₘ,Qₘ and of the same dimensions calculated variables S_{c}, Q_{c}, such that:

$$\begin{matrix}{S}_{c} = {S}_{c} ( ρ , μ ) \\ {Q}_{c} = {Q}_{c} ( ρ , μ ) & ( 1.2 ) \\ \{ \begin{matrix}{S}_{m} - {S}_{c} [ F ( ρ , μ ) ] = 0 \\ {Q}_{m} - {Q}_{c} [ U ( ρ , μ ) ] = 0\end{matrix} & ( 1.3 )\end{matrix}$$

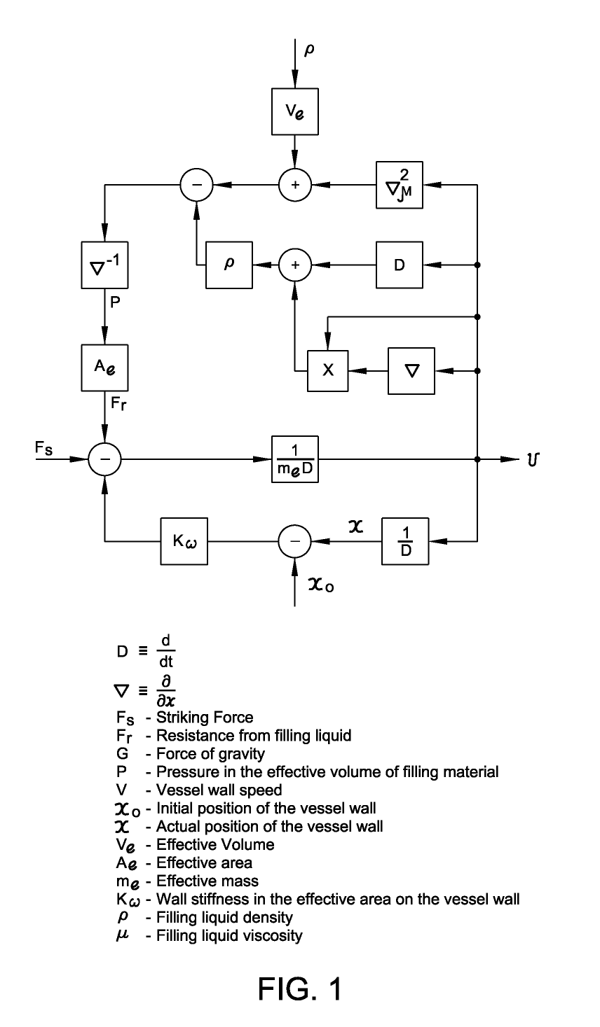

The functions F( ) and U( ) of the (1.3) represent natural laws regulating the relationships between the variables (Sₘ, Qₘ) and the sought variables (ρ, μ). For instance, in an example having the vessel filled with a Newtonian fluid, the functions F( ) and U( ) could be described by the system of equations represented in FIG. 1.

FIG. 1 is presented in the form of a Dynamic Units Block Diagram that can be found in Mathematical Control Theory: Deterministic Finite Dimensional Systems. Second Edition, Texts in Applied Mathematics/6, Eduardo D. Sontag, 1998. which is hereby incorporated by reference in its entirety. Here, the system of the governing equations (1.3) includes the Navier-Stokes system of equations describing the dynamics of the vessel's liquid content in the effective volume linked to the mathematical model of the vessel wall oscillation resulting from the application of the normally-directed mechanical load from the striker.

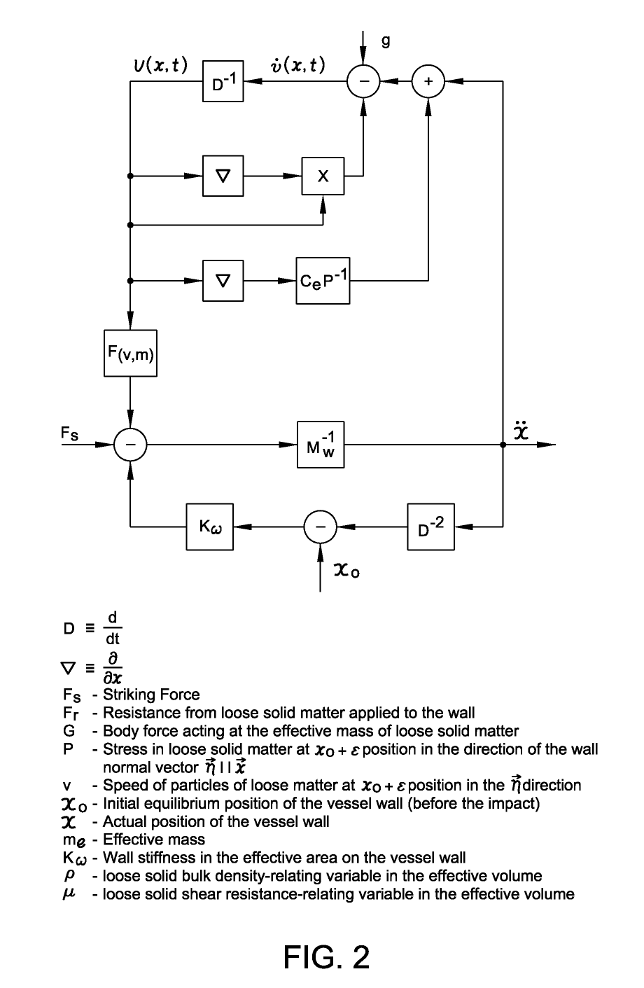

According to an example having the vessel filled with loose solid material, the functions F( ) and U( ) could be described in the case of a one-dimensional problem by the Block Diagram shown in the FIG. 2. FIG. 2 reflects a granular material mathematical model presented in the work of Dr. Loktionova in Analysis of dynamics of vibration-based technologies and equipment for processing non-uniform loose solids: Loktionova O. G., Dr. Sci. Thesis Abstract, 35 pages, which is hereby incorporated by reference in its entirety. Other examples of mathematical models for loose solid materials could be found in the following papers: “FREE-FLOWING MEDIA DYNAMIC PROBLEMS”: V. M. Sadovskii, Mathematical Modeling Vol. 13, No. 5, 2001/Institute of Computational Modeling of Rus. Acad, of Sci; “Kinematics of the motion of loose materials relative to rigid surfaces”: S. B. Stazhevskii and A. F. Revuzhenko, Journal of Mining Science Vol. 11, No. 1, January, 1975, pp. 78-80; “Particle size segregation in inclined chute flow of dry cohesionless granular solids”: S. B. Savage and C. K. K. Lun, Journal of Fluid Mechanics (1988), 189:311-335 Cambridge University Press; “A three-phase mixture theory for particle size segregation in shallow granular free-surface flows”: A. R. THORNTON, J. M. N. T. GRAY and A. J. HOGG, Journal of Fluid Mechanics (2006), 550:1-25 Cambridge University Press, each of which is hereby incorporate by reference in its entirety.

The mathematical description of the dynamic behavior of loose solids is extremely multivariate and depends on the specifics of a measurement project, therefore various mathematical models of the dynamic system “Vessel's wall-Filling material” can be used for the implementation of the Act 1314 of the present method additionally to the models cited. As of particular interest, are the models using both, density and shear resistance relating variables, “a paradigm here is provided by the famous Burgers equation” [Dave Harris proposal at www.maths.manchester.ac.uk/˜dh/MSc Projects/NumAnalProj07.html, en.wikipedia.org/wiki/Burgers%27_equation], which is hereby incorporated by reference in its entirety.
Act 1316: Solving the system of equations against the unknowns, whereby providing simultaneous non-invasive measurement of the density-relating variable and shear resistance relating variable of the filling material present in the associate volume in the vicinity of the center of the mechanical load applied to the vessel wall.

Systems of equations with links and functions described in the FIGS. 1 and 2 cannot be solved analytically even in the most simple cases due to their non-linearity. Therefore, in some examples, the method is implemented by a controller with hardware or software facilities for solving systems of partial differential equations Numerical Recipes in C++: The art of scientific computing, William H. Press, et al.-2^{nd} edition for obtaining real time solutions to (ρ, μ), which is incorporated herein by reference in its entirety.

It is to be appreciated that another important feature of the present invention is that using an adequate mathematical model of the dynamic system “Vessel's wall-Filling material” obviates calibration from the measurement sequence of operations. Additionally, in an example where one of the unknown variables (ρ, μ) is constant, the proposed method of measurement is minimized to solving one equation of the type (1.3):

Wₘ−W_{c}[N(λ)]=0 (1.4)

Wherein Wₘ denotes the measured value of the evaluating variable; W_{c} denotes the calculated evaluating variable; function N(λ) represent natural laws regulating the relationship between the variable Wₘ and the sought variable λ=ρ [symbol] μ.

The equation (1.4) can be solved analytically in a sufficiently small vicinity of a known value λ=λ° or using various kinds of reference tables or calibration curves or numerical methods. In some examples, where the mathematical description of the W_{c}[N(λ)] is not available, the operation of solving the equation (1.4) becomes a process including:
a) Building an experimental curve W_{ce}({λ*}), {λ*}ε[λ′, λ″]—“Calibration”;
b) Solving the equation Wₘ−W_{ce}(λ)=0 against the unknown variable λ=ρ [symbol] μ—“Measurement”
   Wherein, {λ*} denotes a set of pre-measured values of the variable λ. The Calibration operation is a multiple point measurement process with the minimal number of measurements equal to two; the operation is describable by the following system of algebraic equations:

$${{W}^{->}}_{m}^{*} - {W}_{ce} ( {{λ}^{->}}^{*} ) = 0$$

$${W}_{ce} ( {{λ}^{->}}^{*} ) = {\sum }_{i = 1}^{K} {{a}_{i} ( {{λ}^{->}}^{*} )}^{( i )}$$

$${{λ}^{->}}^{*} ⋐ \{ {λ}^{*} \} , K \geq 2$$

Wherein, \vec{W}*ₘ denotes a vector-column of values of the measured evaluating variable W; \vec{λ}* denotes a vector-column of pre-measured values of the sought variable λ=ρ [symbol] μ.

Process 1300 depicts one particular sequence of acts in a particular example. The acts included in process 1300 may be performed by, or using, one or more computer systems specially configured as discussed herein. Some acts are optional and, as such, may be omitted in accord with one or more examples. Additionally, the order of acts can be altered, or other acts can be added, without departing from the scope of the systems and methods discussed herein. In addition, as discussed above, in at least one example, the acts are performed on a particular, specially configured machine, namely a computer system configured according to the examples disclosed herein.

The utility of the present invention is definable by the sensitivity of the wall oscillation to the filling material density/viscosity change. Having this as an objective, two sensitivity trials conducted on tanks filled with liquid (Trial A) and loose solid material (Trial B) will be described below.

### Trial A

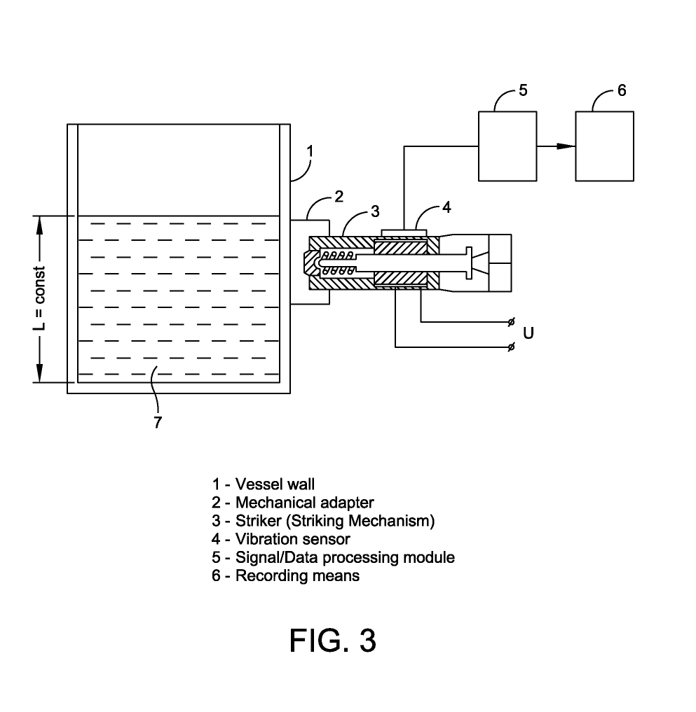

In order to observe the liquid material density/viscosity effect on the vessel wall oscillation, an OMD was mounted on the vessel. The schematic diagram of the experimental installation is shown in the FIG. 3. The monitoring device was equipped with a striking mechanism configured to apply a mechanical impact (a strike) at the outside wall of the vessel and with an accelerometer-based receiver positioned on the body of the striker. For the duration of the trial, the level of liquid in the vessel was kept constant. The vessel was in the fixed position preventing movement while it was being filled or emptied. According to the trial procedure, the vessel was filled with various test liquid substances.

The oscillatory time-response (S) of the vibration sensor was processed by the following:

$$S = \frac{1}{n} {\sum }_{i = 1}^{n} {( {S}_{i} )}^{2} \\ {S}_{i} ≡ {\overline{S} ( t )}_{\vert t = {t}_{i}} \\ \overline{S} ( t ) = \frac{1}{τ} {\int }_{t - τ}^{t} S ( x ) d x \qquad ( 1.5 )$$

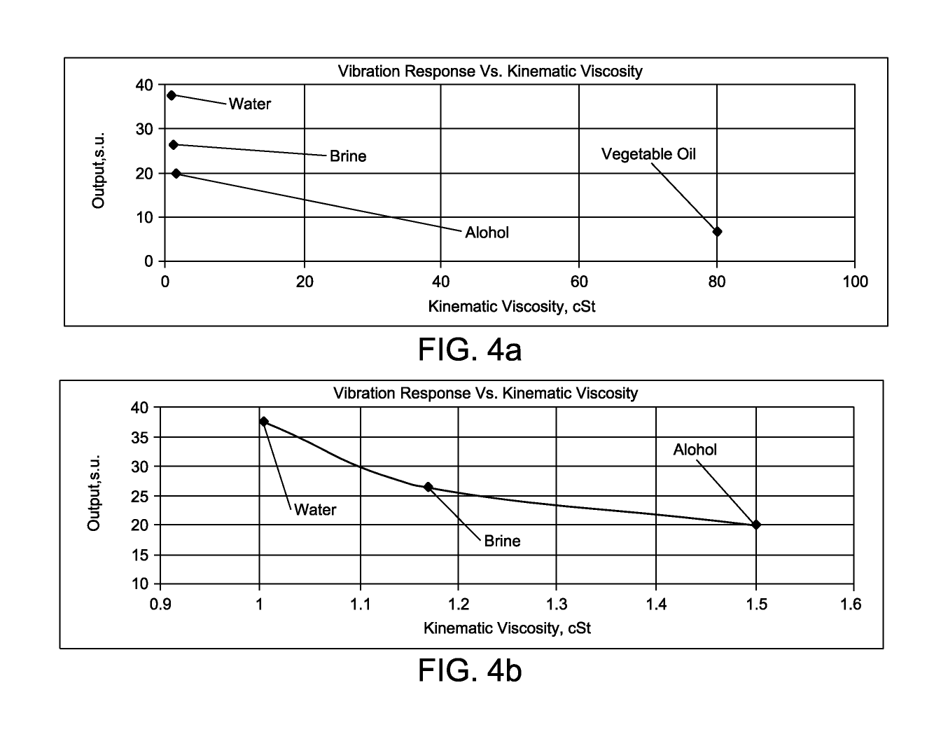

The numerical results of the Trial A tests are presented in Table 1 and graphically illustrated in the FIG. 4. Wherein, density values for testing solutions were determined directly by weighing each sample solution in the vessel of known volume at room temperature; dynamic viscosity values were obtained in the article “Viscosity”: http://hypertextbook.com/physics/matter/viscosity/, which is incorporated by reference herein in this entirety.

TABLE 1

| | | Dynamic | Kinematic | Output |
|---|---|---|---|---|
| | Specific | Viscosity | Viscosity | (S) |
| | Gravity | cP | cSt | s.u. |
| Water | 1 | 1.002 | 1.004 | 37.4 |
| Brine | 1.2 | 1.4 | 1.17 | 26.29 |
| Alcohol | 0.8 | 1.2 | 1.5 | 19.71 |
| Vegetable Oil | 0.9 | 72 | 80 | 6.53 |

The analysis of data of the Trial A led to the conclusion that the oscillatory response of the vessel wall to each single strike is in inverse proportion to the value of kinematic viscosity of the homogeneous liquid filling the test vessel at a constant level L.

In one example of the method, the wall's acceleration variable measured in the vicinity of strikes is used for the evaluation of the vibration response. According to this example, the acceleration variable is evaluated after a temporal mechanical load (a strike) is applied to the wall and then canceled by the striker. However, evaluating the wall's vibration is not limited to the procedure described by the formulas (1.5). Any method definable on the time or the frequency domain that provides the required sensitivity to the density/viscosity of a filling liquid can be applied according to the examples disclosed herein.

### Trial B

### Summary of Tests

The objective of the trial B was to produce, monitor and record changes in the vibration output signal caused by changes in the powder sample bulk density. The desired density change was obtained by the following three methods:
Method 1: Density was changed by modifying the powder sample volume and keeping the powder mass unchanged. Test 1 was conducted by executing Method 1.
Method 2: Density was changed by modifying the powder sample mass and keeping the powder sample volume unchanged. Test 4 was conducted by executing Method 2.
Method 3: Density was changed by means of vibration. Test 2 and Test 3 were conducted by executing Method 3

### Data Processing

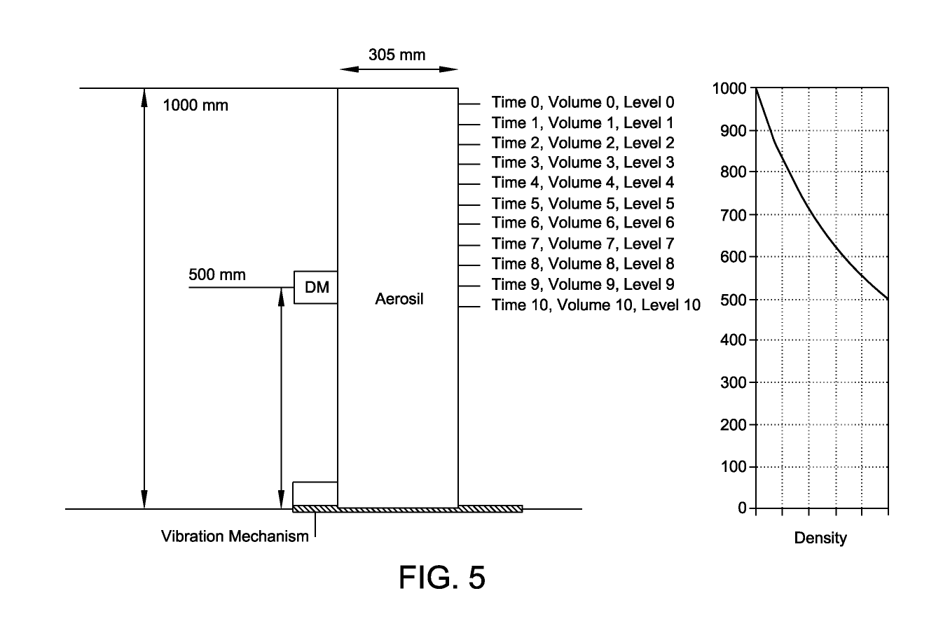

During these tests, the initial bulk density of the powder sample was calculated using the formula:

$$Initial bulk density = \frac{Filled Pipe Weight - Empty Pipe Weight}{Pipe Internal Volume} \qquad ( 1.6 )$$

Wherein the weight was measured in gram-force and the volume was measured in liters. A schematic depiction of the test pipe with the OMD mounted on it is shown in the FIG. 5.

During these tests, the density of the powder sample was calculated as follows:

$$\begin{matrix}Experemental density = \frac{Powder Weight}{Volume \cdot g} \\ = \frac{Powder Weight}{0.25 π {D}^{2} ( H - h ) \cdot g}\end{matrix} \qquad ( 1.7 )$$

Wherein D denotes the pipe internal diameter; H denotes the pipe height; h denotes the distance from the top of the pipe to the powder/air interface and g denotes the gravity constant.

### Data Analysis

OMD Output Evaluation

In these tests, the output of the OMD was evaluated by the following method:

$$U = {\sum }_{i = 1}^{K} ( {U}_{{m}_{i}}^{2} - {U}_{{m}_{i - 1}}^{2} ) \qquad ( 1.8 )$$

Where Uₘ_{ᵢ}² denotes an i^{th} amplitude of the fundamental harmonic of the OMD sensor's conditioned reaction to a strike:

$$\overline{u} ( t ) = {\int }_{t - τ}^{t} u ( x ) d x$$

and K denotes the number of half-periods of oscillations counted on the signal monitoring time-interval.

The experimental sensitivity of the OMD output to the sample bulk density was calculated according to the following formulas:

$$ϛ = \frac{\overline{Δ ρ}}{\overline{Δ U}} \\ {ϛ}_{s} = \frac{100 \overline{Δ U}}{\overline{Δρ} \cdot \overline{U}} \\ \overline{Δρ} = {\overline{ρ}}_{1} - {\overline{ρ}}_{2} \\ \overline{Δ U} = {\overline{U}}_{1} - {\overline{U}}_{2} \qquad ( 1.9 )$$

### Where

$$ϛ ( \frac{g / L}{s . u .} )$$

denotes the OMD sensitivity to the density of the sample; ζₛ denotes the percent of the device's output value change per sample density; Δ̅ρ̅ denotes average density change; Δ̅U̅ denotes averaged evaluated DM output; ρ̅ⱼ denotes mean of the bulk density of the j^{th} powder sample; Ūⱼ denotes mean of the evaluated DM output corresponding with the j^{th} powder sample and s.u. denotes the standard unit the OMD output is represented.

The estimated repeatability of the bulk density measurements was calculated using the following formulas:

$$ρ ∈ [ {ρ}_{min} , {ρ}_{max} ] : \\ ɛ = q \frac{σ}{{ρ}_{max}} \cdot 100 \% \qquad ( 1.10 )$$

Where ε denotes the repeatability of measurement; σ denotes the STD of the device's output variable U; q denotes the coefficient characterizing the sample density-per-measurement volatility that is equal to 1 in the recommended case when the repeatability of the OMD is evaluated on an empty vessel.

For a coarse estimation of the repeatability of measurement, the following empirical formula could be applied:

ε=pζ,

ρε[3,5] (1.11)

### Test 1

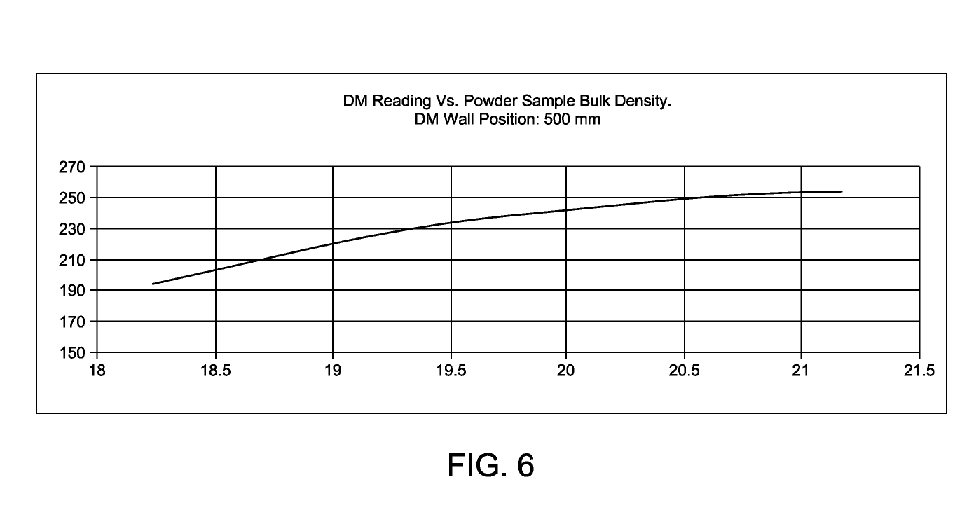

The bulk density of the sample was changed by the method of compression. The recorded and conditioned experimental data are presented in table 2 and the graph below shown in the FIG. 6.

TABLE 2

| Level, | Volume, | Powder | OMD | Density, |
|---|---|---|---|---|
| mm | L | Weight, g | Reading, s.u. | g/L |
| 873 | 66.732 | 1,217.00 | 193.95 | 18.234 |
| 822.2 | 63.025 | 1,217.00 | 228.079 | 19.307 |
| 771.4 | 59.317 | 1,217.00 | 248.045 | 20.513 |
| 746 | 47.464 | 1,217.00 | 252.35 | 21.175 |

### Test 2

The bulk density of the sample was changed by the method of vibration. The recorded and conditioned experimental data are presented in table 3 below.

TABLE 3

| Vibration | OMD | % |
|---|---|---|
| Applied, y/n | Reading, s.u. | Change |
| N | 296.95 | |
| Y | 284.64 | 4.15 |

### Test 3

The Test 2 procedure was repeated when the OMD was attached to the wall at 150 mm from the top of the pipe. The recorded and conditioned experimental data are presented in table 4 below.

TABLE 4

| Vibration | OMD | % |
|---|---|---|
| Applied, y/n | Reading, s.u. | Change |
| N | 505.85 | |
| Y | 492.65 | 2.61 |

### Test 4

The bulk density of the sample was changed by adding a pre-determined powder mass and keeping the material level unchanged. The recorded and conditioned experimental data are presented in the table 5 below.

TABLE 5

| Powder Bulk | OMD |
|---|---|
| Density Category | Reading, s.u. |
| Density_1 | 327.135 |
| Density_2 | 211.567 |

The analysis of the data gather in Trial B supported two observations:

### Observation 1

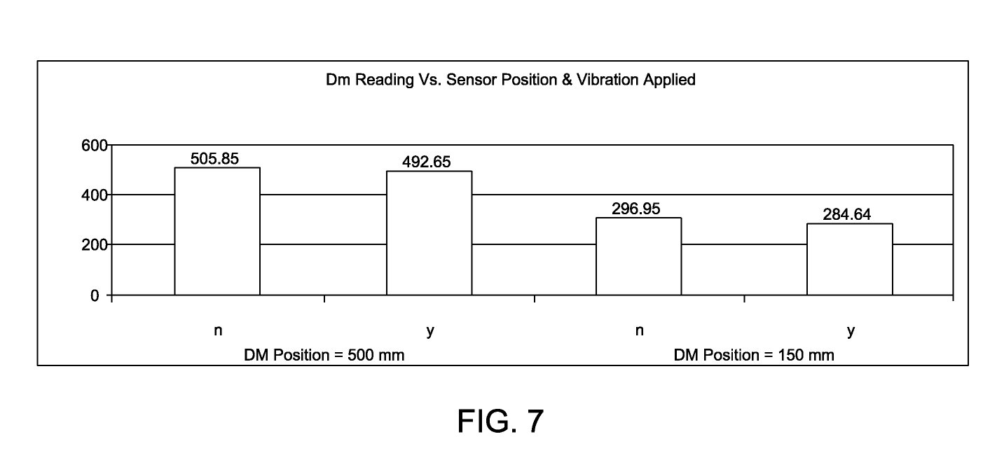

A small density increase in the vicinity of the OMD produced an almost proportional increase in the value of the OMD reading. This observation is supported by the curve in the FIG. 6 where the density of the powder material in the vicinity of the pipe wall point located at 500 mm below the top of the pipe was changed by the application of a relatively small vertical load to the powder layers at the top of the pipe (Test 1). The same observation is true for the Test 2 and Test 3 recordings. Regardless of the OMD position on the tank wall, once the vibration was applied to the wall, the OMD readings decreased in comparison to the readings obtained without vibration. A bar graph of the vibration readings, FIG. 7 shows the data that supports this observation.

### Observation 2

A substantial density increase in the vicinity of the OMD produced a noticeable decrease in the value of the OMD reading. A comparison of the OMD readings obtained for 500 mm position of the OMD on the tank wall with the readings associated with the 150 mm OMD position on the tank wall proves correctness of this observation (Test 2, Test 3). The difference in readings recorded at 500 mm and 150 mm OMD positions can be linked to the difference between the powder densities evaluated in each position. The bulk density at 150 mm from the top of the pipe is substantially smaller than the density at 500 mm from the top of the pipe due to a compressing effect of the powder upper layers. Data from Test 4 also confirms the correctness of this observation. In Test 4, adding the additional powder at the same material level produced a 35% decrease in the OMD reading value.

The phenomenon of opposing trends in the OMD readings dependant on initial density values creates an opportunity for development of a double-scale measuring instrument capable of accurately measuring powder bulk densities with very wide ranges.

The above-described phenomenon can be explained with an analytical expression of the fundamental harmonic of the decaying oscillating reaction of the OMD sensor output signal (u(t)) to an individual strike applied to the pipe wall. A mathematical description of the u(t) has the following view:

u*≈Uₘe^{αt} sin(ωt+φ),

α>0 (1.12)

Where Uₘ represents the fundamental harmonic's amplitude and α denotes the signal's logarithmic decrement characterizing mechanical energy dissipation in the OMD [symbol] Powder Material [symbol] Pipe Wall dynamic system. Feeding the formula (1.8) with u*(t) of the expression (1.12) returns the following formula that will be used in the consequent numerical investigation:

$$U = {\sum }_{i = 1}^{K} ( {U}_{m , i}^{2} - {U}_{m , i - 1}^{2} ) = {\sum }_{i = 1}^{K} ( {U}_{m , i}^{2} {e}^{- 2 α {t}_{i}} {sin}^{2} ( ω {t}_{i} + ϕ ) - {U}_{m , i - 1}^{2} {e}^{- 2 α {t}_{i - 1}} {sin}^{2} ( ω {t}_{i - 1} + ϕ ) ) \qquad ( 1.13 )$$

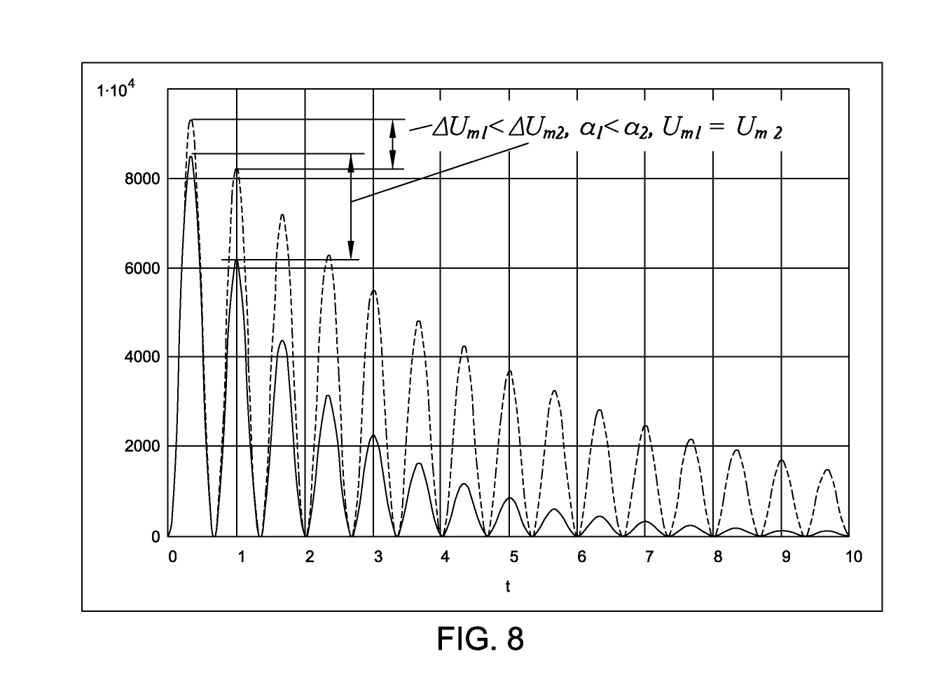

A graphical representation of the expression (1.13) is shown in the FIG. 8.

The processes shown in FIG. 8 illustrate the case when the density changes in relatively small values affecting the logarithmic decrement a (internal friction) but leaving practically unchanged the fundamental harmonic amplitude. The sum of the adjacent amplitude differences for the “dotted line curve” is smaller than the sum of the adjacent amplitude differences for the “solid line curve”. In this example, the “dotted line curve” is associated with the lower density material and the “solid line curve” is associated with the greater density material.

The opposite picture appears when the density of the powder material changes substantially. In this case, the fundamental harmonic amplitude of the investigated mechanical dynamic system reduces noticeably due to a large increase in the mechanical dynamic system's stiffness. The application of the formula (1.13) returns the opposite result. In order to prove this conclusion, the two hypothetical cases were analyzed numerically at the following parameters:

Case 1:
(ρ₁ is substantially greater ρ₂₎

| | |
|---|---|
| Uₘ₁ = 60 | Uₘ₂ = 100 |
| α₁ = 0.25 | α₂ = 0.25 |
| U = 1401.19 | U = 1812.33 |

Case 2:
(ρ₁ is slightly greater ρ₂₎

| | |
|---|---|
| Uₘ₁ = 95 | Uₘ₂ = 100 |
| α₁ = 0.15 | α₂ = 0.1 |
| U = 2328.7 | U = 1812.33 |

### OMD Experiment-Based Sensitivity and OMD Estimated Repeatability

Various types of variables evaluating the quality of a measuring device were described in the formulas (1.9-1.13). Using these formulas and numerical results of Test 1, allows determination of sensitivity of density measurement by an OMD prototype.

$ζ = \frac{Δ ρ}{Δ U}$

| Δρ, g/L | ΔU, s.u. | ζ, g/L · s.u. |
|---|---|---|
| 1.073 | 34.129 | 0.031 |
| 1.207 | 19.966 | 0.06 |
| 0.662 | 4.305 | 0.154 |

Experimental OMD Density Measurement Repeatability derived from the formula (1.11)

$ɛ = p \frac{λ}{{ρ}_{max}} \cdot 100 \%$
p = 5, ρₘₐₓ = 150 g/L

| λ, g/L · s.u. | ε, % |
|---|---|
| 0.031 | 0.103 |
| 0.06 | 0.020 |
| 0.154 | 0.513 |

The results of the tests performed according to the schedule of the Trial B demonstrated the applicability of the method of the present invention to measurement of bulk density of loose solid materials, especially very light powders of the tested bulk density range of 20-150 g/L with an aggregated repeatability 0.212%.

In general, the outcome of the described trials showed that:
Monitoring vessels wall oscillatory response delivers information about the filling material density with sufficient resolution allowing building non-invasive measuring devices utilizing the vessel wall as a sensitive membrane and
A family of data-processing methods can be generated using the vessel wall oscillatory response to obtain density or shear resistance relating variable measurement with accuracy meeting or exceeding the requirements of industrial process control systems. In one example, the basic set of formulas the data-processing methods can be built on include expressions (1.5, 1.8, 1.13).

### Measurement Apparatus

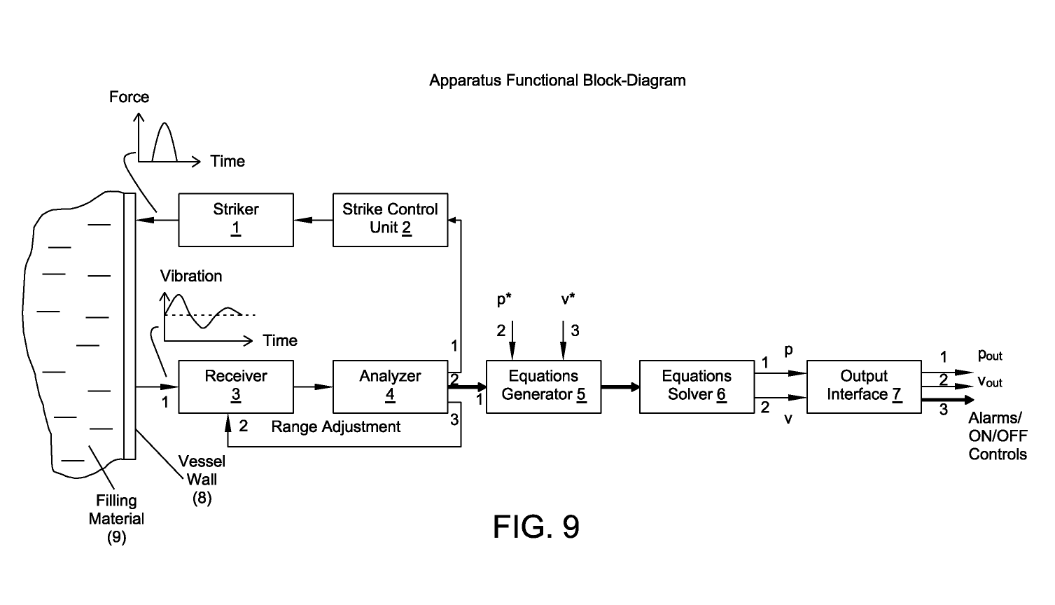

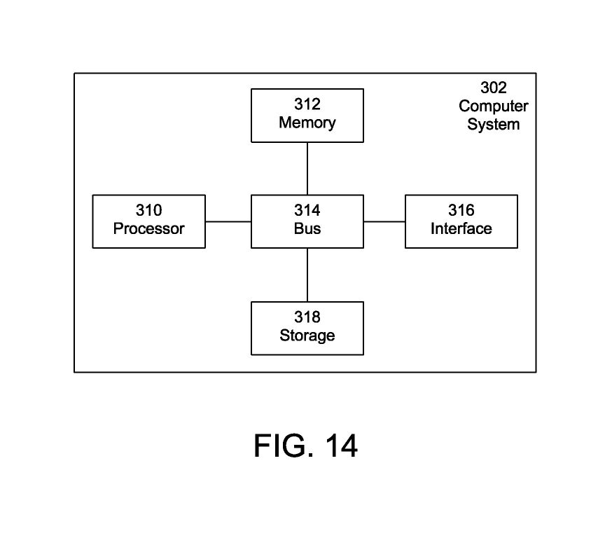

According to various examples, the method for simultaneous measurement of density and shear resistance relating variable is implemented by a measurement apparatus. The apparatus' principle of operation and functionality will be described using its functional block diagram shown in the FIG. 9. The measurement apparatus is comprised of the following functional units: a striker 1, a strike control unit 2, a receiver 3, an analyzer 4, an equations generator 5, an equations solver 6 and an output interface 7. The units 1 and 3 make a Sensor/Receiver Module of the apparatus. The units 2, 4-6 make a Processing Module of the device. According to some examples, the measurement apparatus may include a computer system, such as the computer system described with reference to FIG. 14 below, to implement one or more of its functions. It is to be appreciated that the computer system included within the measurement apparatus may be a relatively simple computer system, such as a controller with embedded memory.

The output of the Receiver 3 is coupled to the input of the Analyzer 4. The first output of the Analyzer is coupled to the input of the Strike Control Unit 2 which output is connected to the input of the Striker respectively. The second output of the Analyzer is connected to the first input of the Equation Generator 5. The third output of the Analyzer is connected to the second input of the Receiver. The guess value for the density variable is the 2^{nd} input of the Equations Generator. The guess value of the shear resistance relating variable is the 3^{rd} input of the Equations Generator. The vector-output of the Equations Generator is connected to the input of the Equations Solver unit 6, which first output is the measured density variable and the second output is the measured shear resistance relating variable. The first output of the Equations Solver is connected to the first input of the apparatus' Output Interface unit 7. The second output of the Equations Solver is connected to the second input of the apparatus' output interface. The first output of the unit 7 delivers information about the measured density outside the measurement apparatus. The second output of the unit 7 delivers information about the measured shear resistance relating variable outside the measurement apparatus. The third output of the unit 7 is a vector of binary alarms for various versions of ON/OFF control.

The apparatus works according to the following description. Driven by the signal from the Strike Control Unit 2 that executes the strike optimization procedure in accordance with the Act 1304 of the disclosed measurement method, the Striker 1 applies a mechanical impact at the wall 8 of the vessel. The impact can be a single pulse, a series of pulses or a modulated continuous periodical load. The vessel wall is excited by the impact and consequently involves a portion of the filling material 9 in the oscillating process. The wall's oscillatory response is captured by the Receiver 3. The Receiver 3 may include a vibration sensor and an amplifier. The output of the Receiver 3 can be conditioned and prepared for further processing having the Receiver 3 and the Analyzer 4 sharing the execution of one or more of procedures similar to those described in the expressions (1.5, 1.8, and 1.13).

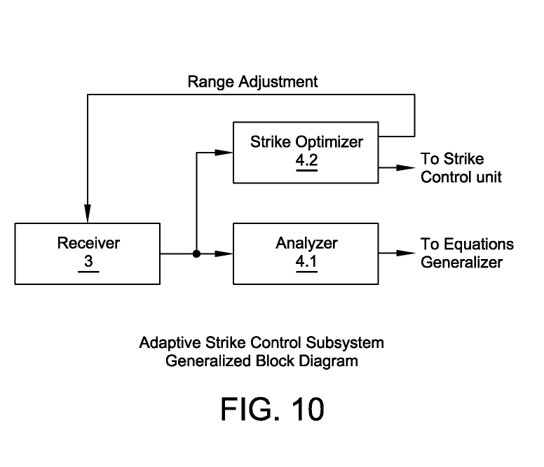

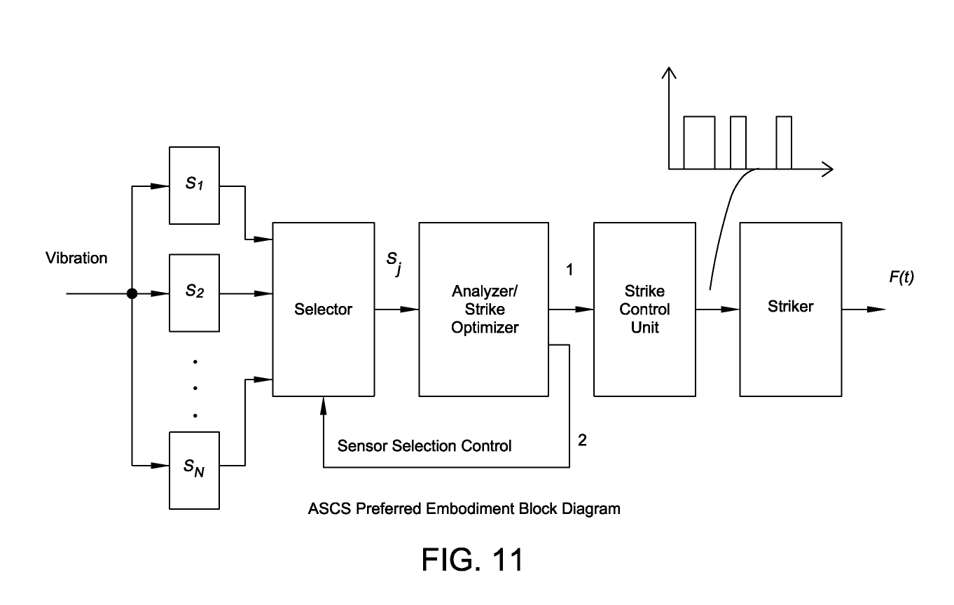

The 1^{st} output of the Analyzer 4 controls the type of the mechanical impact the Striker 1 applies to the wall by modifying the amount of kinetic energy the striker delivers to the wall. Depending on the type of the driving energy used to move the striker mechanism, the driving force could be produced by voltage or by electrical current-over-time of the electromagnetic driving system, e.g., a solenoid or a linear motor; pressure or flow-over time of the hydraulic or pneumatic driving system, etc. The 3^{rd} output of the Analyzer 4 controls the range of the sensory system of the Receiver 3 in accordance with the acquired vibration signal quality criteria, thereby closing the feedback of the Adaptive Strike Control Subsystem (ASCS) including the Receiver 3, Analyzer 4 and Strike Control 2 functional units of the device. A generalized block diagram of the ASCS according to one example is shown in the FIG. 10. According to this diagram, the Strike Optimizer 4.2 analyzes the wall's oscillatory response and automatically changes the dynamics of the Striker movement to optimize the quality of the signal captured by the Receiver 3. One possible implementation of the automatic strike control system is depicted in the drawing of the FIG. 11. The ASCS shown in FIG. 11 functions as follows. The group of sensors (Sⱼ, j=(j= 1̅,̅N̅) acquires vibration of the wall. The Selector unit chooses the particular sensor, which output satisfies the criteria of the vibration signal quality. The Selector is controlled by the feedback from the Analyzer's Strike Optimizer unit's 2^{nd} output. The 1^{st} output of the Analyzer's Strike Optimizer sends control signals to the Strike Control Unit that controls the power of the Striker. The Striker could be controlled using the pulse-width modulation method. The vibration signal quality criteria may have various representations. The preferred embodiment representation of the criteria includes the dynamic range constraint, the signal-to-noise ration constraint and the representative length constraint. The Strike Control Unit optimizes the control sequence at the input of the Striker such that the combination of the selected vibration sensor and the impulse of force produced by the Striker create the dynamic response of the vessel wall that is satisfactory to the vibration signal quality criteria.

Returning now to FIG. 9, the 2^{nd} output of the Analyzer is a vector-output including in the general case the measured variables Sₘ[F(ρ, μ)] and Qₘ[F(ρ, μ)] of the system of equations (1.3). The Equations Generator 5 accepts the variables Sₘ and Qₘ to populate the system of equations (1.3). The guess values (ρ*,ν*) of the unknowns (ρ,ν) are the components of the guess vector required for numerically solving the system of equations (1.3). The values for (ρ*,ν*) are stored in a data storage available to the unit 5. The output of the unit 5 is the numerically-populated system of equations (1.3). This system of equations is being solved by the Equations Solver Unit 6 that may realize at least one method suitable to solving the class of equations represented by the block diagrams shown in the FIG. 1 and FIG. 2. The outcome of solving the system of equations (1.3) is the numerical values of the density and the shear resistance relating variable associated with the instance of the filling material transient state at the moment the output to the Receiver 3 has been captured. Depending on the type of the filling material, the pair of calculated=measured variables (ρ,ν) may represent respectively: a) density, dynamic viscosity for homogeneous liquids; b) bulk density, viscosity for heterogeneous liquids; and c) bulk density, shear resistance relating variable for loose solids. It is to be appreciated that measurement of the kinematic viscosity is also possible by the various examples disclosed herein. The Sensor/Receiver Module of the apparatus and the Processing Module of the apparatus are not the functional elements of the system but the design modules; they may have multiple implementations including a single part design when both modules are situated in the same enclosure. For example, in one of the tested design solutions for the apparatus, the Sensor/Receiver Module was built according to the drawing depicted in the FIG. 11.

Applications of the examples disclosed herein may include measurement of variables other then the density and viscosity or another shear resistance relating variable. For example, combining the disclosed method and device for density measurement with a non-invasive volumetric flow measuring device, e.g., an ultrasound flow meter using Doppler Effect could easily make the apparatus of the present invention suitable for measuring mass flow—an important variable characterizing a large variety of industrial processes.

Another application of some examples allows the cross-sectional analysis of the viscosity and/or density of content materials. This application is described with the reference to FIG. 12. According to the sketch, the cross-sectional profiling of the viscosity/density of the non-gaseous free-flowing material could be obtained by a consequent change of the striking force from weak to strong (strong to weak) strikes such that different material volume could be involved in the oscillating process. Another example of the same application includes an acoustical emitter 1 and receiver 2 sending and receiving elastic waves propagating through the width of the content material at the same time the strikes are applied to the wall's outer surface. In this case, the acoustical wave parameters such as amplitude, phase shift, higher harmonics of the acoustic envelope, etc., become dependent on the amount of energy each strike brings into the oscillating system, thereby providing for the non-invasive density/viscosity measurement at various layers of the content material along the cross-sectional dimension of the vessel.

Referring to FIG. 14, there is illustrated a block diagram of a computer system 302, in which various aspects and functions disclosed herein may be practiced. The computer system 302 may include one more computer systems that exchange (i.e. send or receive) information. As shown, the computer system 302 may be interconnected by, and may exchange data through, a communication network. The network may include any communication network through which computer systems may exchange data. To exchange data using the network, the computer system 302 and the network may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST and Web Services. To ensure data transfer is secure, the computer system 302 may transmit data via the network using a variety of security measures including, for example, TSL, SSL or VPN. The network may include any medium and communication protocol.

FIG. 14 illustrates a particular example of a computer system 302. As illustrated in FIG. 14, the computer system 302 includes a processor 310, a memory 312, a bus 314, an interface 316 and data storage 318. The processor 310 may perform a series of instructions that result in manipulated data. The processor 310 may be a commercially available processor such as an Intel Xeon, Itanium, Core, Celeron, Pentium, AMD Opteron, Sun UltraSPARC, IBM Power5+, or IBM mainframe chip, but may be any type of processor, multiprocessor or controller. The processor 310 is connected to other system components, including one or more memory devices 312, by the bus 314.

The memory 312 may be used for storing programs and data during operation of the computer system 302. Thus, the memory 312 may be a relatively high performance, volatile, random access memory such as a dynamic random access memory (DRAM) or static memory (SRAM). However, the memory 312 may include any device for storing data, such as a disk drive or other non-volatile storage device. Various examples may organize the memory 312 into particularized and, in some cases, unique structures to perform the functions disclosed herein.

Components of the computer system 302 may be coupled by an interconnection element such as the bus 314. The bus 314 may include one or more physical busses, for example, busses between components that are integrated within a same machine, but may include any communication coupling between system elements including specialized or standard computing bus technologies such as IDE, SCSI, PCI and InfiniBand. Thus, the bus 314 enables communications, such as data and instructions, to be exchanged between system components of the computer system 302.

The computer system 302 also includes one or more interface devices 316 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 302 to exchange information and communicate with external entities, such as users and other systems.

The data storage 318 may include a computer readable and writeable nonvolatile (non-transitory) data storage medium in which instructions are stored that define a program or other object that may be executed by the processor 310. The data storage 318 also may include information that is recorded, on or in, the medium, and this information may be processed by the processor 310 during execution of the program. More specifically, the information may be stored in one or more data structures specifically configured to conserve storage space or increase data exchange performance. The instructions may be persistently stored as encoded signals, and the instructions may cause the processor 310 to perform any of the functions described herein. The medium may, for example, be optical disk, magnetic disk or flash memory, among others. In operation, the processor 310 or some other controller may cause data to be read from the nonvolatile recording medium into another memory, such as the memory 312, that allows for faster access to the information by the processor 310 than does the storage medium included in the data storage 318. The memory may be located in the data storage 318 or in the memory 312, however, the processor 310 may manipulate the data within the memory 312, and then copy the data to the storage medium associated with the data storage 318 after processing is completed. A variety of components may manage data movement between the storage medium and other memory elements and examples are not limited to particular data management components. Further, examples are not limited to a particular memory system or data storage system.

Although the computer system 302 is shown by way of example as one type of computer system upon which various aspects and functions may be practiced, aspects and functions are not limited to being implemented on the computer system 302 as shown in FIG. 3. Various aspects and functions may be practiced on one or more computers having a different architectures or components than that shown in FIG. 3. For instance, the computer system 302 may include specially programmed, special-purpose hardware, such as an application-specific integrated circuit (ASIC) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 302 may be a computer system including an operating system that manages at least a portion of the hardware elements included in the computer system 302. In some examples, a processor or controller, such as the processor 310, executes an operating system. Examples of a particular operating system that may be executed include a Windows-based operating system, such as, Windows NT, Windows 2000 (Windows ME), Windows XP, Windows Vista or Windows 7 operating systems, available from the Microsoft Corporation, a MAC OS System X operating system available from Apple Computer, one of many Linux-based operating system distributions, for example, the Enterprise Linux operating system available from Red Hat Inc., a Solaris operating system available from Sun Microsystems, or a UNIX operating systems available from various sources. Many other operating systems may be used, and examples are not limited to any particular operating system.

The processor 310 and operating system together define a computer platform for which application programs in high-level programming languages may be written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, or C# (C-Sharp). Other object-oriented programming languages may also be used. Alternatively, functional, scripting, or logical programming languages may be used.

Additionally, various aspects and functions may be implemented in a non-programmed environment, for example, documents created in HTML, XML or other format that, when viewed in a window of a browser program, render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Thus, functional components disclosed herein may include a wide variety of elements, e.g. executable code, data structures or objects, configured to perform the functions described herein. Further, aspects and functions may be implemented in software, hardware or firmware, or any combination thereof. Thus, aspects and functions may be implemented within methods, acts, systems, system elements and components using a variety of hardware and software configurations, and examples are not limited to any particular distributed architecture, network, or communication protocol.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

Having thus described several aspects of at least one example, it is to be appreciated various alterations, modifications, and improvements will readily occur to those skilled in the art. For instance, while the bulk of the specification discusses detection of check fraud, examples disclosed herein may also be used in other contexts such as to detect other types of fraud within industries other than the financial industry, such as the healthcare industry. Such alterations, modifications, and improvements are intended to be part of this disclosure, and are intended to be within the scope of the examples discussed herein. Accordingly, the foregoing description and drawings are by way of example only.

What is claimed is:

1. A method for measuring physical properties of material in a vessel, the method comprising:
initiating a vibration on a wall of the vessel;
capturing a response to the vibration;
producing values for at least two evaluating variables based on the response; and
solving a system of equations including at least one density variable and at least one shear resistance variable using the at least two evaluating variables.

2. The method according to claim 1, wherein initiating the vibration includes applying a mechanical load to an outside wall of the vessel.

3. The method according to claim 2, wherein applying the mechanical load includes applying at least one of a single pulse, a trainload of pulses and a continuous periodic load.

4. The method according to claim 1, wherein initiating the vibration includes initiating a vibration in the material, the material being at least one of a homogeneous liquid, a loose solid material and a heterogeneous material including a mixture of liquid and solid materials.

5. The method according to claim 1, wherein capturing the response includes capturing informative variables characterizing the wall response to the vibration.

6. The method according to claim 1, further comprising analyzing the response to determine at least one of a set of maximums of an alternating signal obtained on a moving time-window greater then a sampling period, a sum of the set of maximums and a sum of differences between adjacent maximums of the set.

7. The method according to claim 1, further comprising analyzing the response to determine a signal logarithmic decrement or damping factor.

8. The method according to claim 1, further comprising analyzing the response to determine a harmonic spectrum of a signal.

9. The method according to claim 1, further comprising adjusting an amount of kinetic energy used to initiate the vibration by analyzing the response.

10. The method according to claim 9, wherein adjusting the amount of kinetic energy includes verifying the amount of kinetic energy results in another response to a vibration that meets a predetermined set of threshold characteristics.

11. An apparatus for measuring physical properties of material in a vessel, the apparatus comprising:
a striker configured to initiate a vibration on a wall of the vessel;
a sensor configured to capture a response to the vibration; and
a controller configured to:
produce values for at least two evaluating variables based on the response; and
solve a system of equations including at least one density variable and at least one shear resistance related variable using the at least two evaluating variables.

12. The apparatus according to claim 11, wherein the striker is configured to apply a mechanical load to an outside wall of the vessel.

13. The apparatus according to claim 12, wherein the mechanical load includes at least one of a single pulse, a trainload of pulses and a continuous periodic load.

14. The apparatus according to claim 11, wherein the material includes at least one of a homogeneous liquid, a loose solid material and a heterogeneous material including a mixture of liquid and solid materials.

15. The apparatus according to claim 11, wherein the sensor is configured to capture informative variables characterizing the wall response to the vibration.

16. The apparatus according to claim 11, wherein the controller is further configured to analyze the response to determine at least one of a set of maximums of an alternating signal obtained on a moving time-window greater then a sampling period, a sum of the set of maximums and a sum of differences between adjacent maximums of the set.

17. The apparatus according to claim 11, wherein the controller is further configured to analyze the response to determine a signal logarithmic decrement or damping factor.

18. The apparatus according to claim 11, wherein the controller is further configured to analyze the response to determine a harmonic spectrum of a signal.

19. The apparatus according to claim 11, further comprising a strike controller coupled to the striker and the sensor and configured to adjust, by analyzing the response, an amount of kinetic energy used by the striker to initiate the vibration.

20. The apparatus according to claim 19, wherein the strike controller is further configured to verifying the amount of kinetic energy results in another response to a vibration that meets a predetermined set of threshold characteristics.
